(19) United States
(12) Patent Application Publication
(10) Pub. No.: US 2019/0350174 A1
(43) Pub. Date: Nov. 21, 2019

(54) METHOD FOR PROVIDING NUTRITION AND WATER TO NEWLY HATCHED BIRDS OR REPTILES

(71) Applicant: PAS REFORM B.V., Zeddam (NL)

(72) Inventors: Maria Leonie BOERJAN, Zeddam (NL); Wouter Sebastiaan BRUINS, Leiden (NL); Wil Marijn STUTTERHEIM, Leiden (NL)

(73) Assignee: PAS REFORM B.V., Zeddam (NL)

(21) Appl. No.: 16/347,918

(22) PCT Filed: Nov. 7, 2017
(86) PCT No.: PCT/NL2017/050720

§ 371 Date: May 7, 2019

(30) Foreign Application Priority Data
Nov. 7, 2016 (NL) 2017735

(51) Int. Cl. A01K 45/00; A23K 50/70

(52) U.S. Cl. CPC A01K 45/005; A23K 10/20; A23K 50/70

(57) ABSTRACT

The present invention relates to a method for providing food and water for consumption and digestion by: newly hatched birds or newly hatched reptiles undergoing incubation; and/or baby birds and baby reptiles being transported after incubation. The birds or reptiles are fed edible insects and/or edible parts of insects during their incubation or transport.

### FIELD OF THE INVENTION

The present invention relates to a method of providing a bird or reptile with a source of nutrition and preferably water, for its consumption and digestion immediately or soon after its hatching from its egg during its incubation and/or during its transport after incubation. The invention also relates to a composition for providing the source of nutrition and water. The invention further relates to a method for incubating newly hatched birds or reptiles, for providing newly hatched chicks or reptiles access to a source of nutrition and water directly after hatching inside the incubator and while under incubation conditions, or transporting birds or reptiles after incubation with the source of nutrition and water. The invention still further relates to a method for strengthening newly hatched birds or reptiles during their incubation and birds or reptiles during their transport after incubation with the nutrition and water.

### BACKGROUND OF THE INVENTION

In raising poultry, newly laid eggs are typically incubated in large batches under hot, at about 37° C., and dry conditions as provided by high air velocity and/or relative low humidity for up to 21 days until all the fertilized eggs have hatched, or until they should have hatched. Only then the batch of newly hatched birds are removed, and fed with a starter or pre-starter source of food for the birds.

Normally, most chicken eggs hatch in the period between 18 and 21 days after incubation has begun. Unfortunately, many of the birds that hatch earlier than others during the final three days of incubation, e.g. at day 18 are exposed to the conditions of the incubator, including forced air supply, high temperature, and low humidity, suffer subsequent growth and disease problems. These problems arise principally because of a lack of food and water, available to the birds that hatch earlier during these last three days for their consumption.

Research has shown that these chicks, for their further development and resistance to diseases, would benefit from providing food and water as soon as possible after hatching. See: “Spread of hatch and delayed feed access affect post hatch performance of female broiler chicks up to day 5” Animal (2014), 8:4, pp 610-617; and “The Effects of the Spread of Hatch and Interaction with Delayed Feed Access After Hatch on Broiler Performance Until Seven Days of Age” 2005 Poultry Science (2005) 84:1314-1320. For this reason, it has been recommended that newly hatched chicks be fed with water and a food such as a corn- wheat- soybean-based starter diet, immediately after hatching.

Different sources of food were proposed as well, some of which included insect proteins. Hwangbo , J. et al., in “Utilization of house fly-maggots, a feed supplement in the production of broiler chickens”, July 2009, Journal of Environmental Biology, Vol. 30, nr. 4, p. 609-614, discloses the co-feeding of dried house fly maggots and/or starter feed to chicks after incubation. While comprising valuable amino acids, the dried maggots do not contribute to the water supply of the chick, and since they were grown on chick droppings, may create a vector for diseases, endangering the chick population. Despins, J.L. et al., “Feeding Behavior and Growth of Broiler Chicks Fed Larvae of the Darkling Beetle, Alphitobius diaperinus”, 1995, Poultry Science, Vol. 74, nr. 2, p. 331-336 discloses the use of darkling beetle larvae as food or food supply for 3 to 8 day old chicks, whereby the larvae were supplied in the litter of pens, although it is not discloses that the larvae were alive. While the co-feeding of these larvae was considered feasible, although inferior to the starter feed, the danger of the function of the larvae as vector for diseases endangering the chick population was highlighted. Ramos-Elorduy, J . et al., “Use of Tenebrio molitor (Coleoptera:Tenebrionidae) to Recycle Organic Wastes and as Feed for Broiler Chickens” , February 2002, Journal of Economic Entomology, Vol. 95, Nr. 1, p. 214-220, discloses the use of a larvae in the feed of 7 day old chicks as a partial replacement for soybean meal. However, the larvae are incorporated into the feed, and are not likely to be live after this treatment. Accordingly, the larvae are not likely to maintain their water level.

Moreover, problems arise during the transport of newly hatched chicks because of a lack of food and water, not being available to them for consumption during transport. Research has shown that these chicks, for their further development and resistance to diseases, would benefit from providing them with food and water during transport.

Ways have been sought for providing all newly hatched chicks with food and water as soon as possible after hatching during incubation and thereafter until they are placed in a final poultry or egg-laying farming environment where they will be fed a conventional corn and soybean meal containing essential vitamins and minerals.

### SUMMARY OF THE INVENTION

It is therefore an object of the present invention to provide a method for providing food and advantageously also water for consumption and digestion by birds or reptiles when newly hatched and undergoing incubation and/or when undergoing transport after incubation. It is also an object of this invention to provide a composition containing food and advantageously also water for the birds or reptiles when newly hatched and undergoing incubation and/or when undergoing transport after incubation. It is a further object of this invention to provide a method for incubating or subsequently transporting birds or reptiles by giving them the composition of food and advantageously also water during their incubation when newly hatched and and/or during their transport after incubation. It is a further object of this invention to provide a method for strengthening birds or reptiles by giving them the composition of food and advantageously also water during their incubation, when newly hatched and/or during their transport after incubation.

Accordingly, one aspect of the present invention relates to a method for providing food and advantageously also water for consumption and digestion by: newly hatched birds or newly hatched reptiles, advantageously birds, more advantageously chicks, ducklings, baby geese or baby turkeys, still more advantageously chicks, undergoing incubation; and/or birds and reptiles, advantageously baby birds or baby reptiles, more advantageously baby birds, still more advantageously chicks, ducklings, baby geese or baby turkeys, yet more advantageously chicks, being transported after incubation, advantageously soon or immediately after incubation.

The method comprises the step of providing, to the birds or reptiles, edible insects and/or edible parts of insects during the incubation or transport of the birds or reptiles. Advantageously, whole edible insects, more advantageously whole edible insects that are alive, still more advantageously whole live larvae of edible insects, are provided to the birds or reptiles. Also advantageously, newly hatched birds or newly hatched reptiles undergoing incubation are provided with the edible insects and/or edible insect parts less than 7 days after, more advantageously less than 3 days after, yet more advantageously less than 1 day after, still more advantageously just before or as soon as possible after, the birds or reptiles hatch. Also advantageously, birds or reptiles, being transported after incubation, are provided with the edible insects and/or edible insect parts: shortly before, or as soon as possible after, transport begins of the birds or reptiles. Also advantageously, birds or reptiles undergoing incubation or transport, after incubation, are also provided with:
an additional source of water, advantageously a source of water that does not dry out under prolonged heating conditions, more advantageously an exogenous deep eutectic solvent that comprises water and two or more, primary metabolites, advantageously selected from sugars, sugar alcohols, amino acids, organic acids and choline derivatives; or
an additional source of edible food, advantageously derived from one or more grains, more advantageously derived from corn, rice, wheat and/or soybean; or
both the additional source of water and the additional source of edible food. Another aspect of the present invention relates to a composition for providing food and advantageously also water for consumption and digestion by: i) birds or reptiles when newly hatched and undergoing incubation; or ii) birds and reptiles, preferably baby birds and baby reptiles, when being transported after incubation, advantageously immediately or soon after incubation. The composition comprises edible insects and/or edible insect parts, advantageously whole edible insects, more advantageously whole edible insects that are alive, still more advantageously whole live edible insect larvae. Advantageously, the composition also comprises:
an additional source of water, advantageously a source of water that does not dry out under prolonged heating conditions, more advantageously an exogenous deep eutectic solvent that comprises water and two or more, primary metabolites, advantageously selected from sugars, sugar alcohols, amino acids, organic acids and choline derivatives; or
an additional source of edible food, advantageously derived from one or more grains, more advantageously derived from corn, wheat and/or soybean; or
both the additional source of water and the additional source of edible food.

A further aspect of the invention relates to a method for incubating newly hatched birds or newly hatched reptiles and/or transporting birds or reptiles, advantageously baby birds or baby reptiles, after their incubation, advantageously soon or immediately after their incubation, by feeding them the above-described composition of food and advantageously also water when incubating and/or when transporting.

A still further aspect of the invention relates to a method for strengthening newly hatched birds or newly hatched reptiles when incubating them and/or for strengthening birds or reptiles, advantageously baby birds or baby reptiles, when transporting them, advantageously soon or immediately after their incubation, by feeding them the above-described composition of food and advantageously also water when incubating and/or when transporting.

### DETAILED DESCRIPTION OF THE INVENTION

Unless otherwise stated, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention.

The term “edible insect” as used herein preferably means an insect which can be safely used as a food source for humans and/or birds and/or reptiles, particularly humans, and can also be consumed and/or digested by birds and/or reptiles. Examples of edible insects are set forth in the report: “Edible insects: future prospects for food and feed security”, FAO Forestry Paper 171, Food and Agriculture Organization of the United Nations (Rome, 2013); and in the articles: “Insects—a natural nutrient source for poultry—a review”, Ann. Anim. Sci., Vol. 16, No. 2 (2016) 297-313; “Black soldier fly as dietary protein source for broiler quails . . . ”, Animal, pages 1-8, © The Animal Consortium 2016; and “Extraction and characterisation of protein fractions from five insect species”, Food Chemistry 141 (2013) 3341-3348.

Among “edible insects” are grasshoppers, soldier flies, crickets, cockroaches, termites, lice, stink bugs. cicadas, aphids, scale insects, psyllids, beeties, caterpillars, fleas, bees, wasps and ants, as well as desert locusts, housefly maggots and silkworms, and in CN 104489391 A (8 Apr. 2015). While all stages of edible insects can be used, the larval stage is preferred.

Preferred edible insects, particularly for birds, more particularly for baby birds, still more particularly for newly hatched birds, yet more particularly for newly hatched chicks, are live edible insects.

Preferred species of edible insects include the lesser meal worm (Alphitobius diaperinus), the buffalo worm (Alphitobius laevigatus) and the meal worm beetle (Tenebrio molitor), particularly their larvae, more particularly the larvae of the lesser meal worm. In this regard, the average dimensions of the larvae of the lesser meal worm, with a maximal reported length of 20 mm, appears to provide an ideal length and proportion for newly hatched birds, particularly newly hatched chicks.

Preferably, the edible insects and their parts do not serve as a vector for pathogens that could negatively a bird or reptile. Where a species is known to act as a vector, the edible insect is preferably bred to be free from harmful pathogens for the bird or reptile.

Particularly for birds, more particularly for baby birds, still more particularly for newly hatched birds, yet more particularly for newly hatched chicks, the edible insects or their parts preferably have a maximum average length of 15 mm, more preferably 14 mm, yet more preferably 13 mm, even more preferably 12 mm, still more preferably 11 mm. However, longer edible insects or their parts (e.g., up to 20 mm) can be used. The minimum average length preferably is at least 5 mm, more preferably at least 6 mm. By average length, the larger dimension is considered as length, whereas the smaller dimension is considered as width, as edible insects typically have a larger and a smaller dimension, independently from their stage.

It has been found that baby birds, particularly newly hatched birds, more particularly newly hatched chicks, are especially attracted to whole live edible insects. Without wishing to be bound by any particular theory, it is believed that movement of live insects can trigger a hunting or feeding reflex in the baby birds and thus can lead to an early uptake of the insects as a source of food and water. Since live insects maintain their water content as part of their metabolism, the amounts of both food and water (i.e., about 60-71 wt. of water) for live insects and larvae are usually appropriate for the nutrition and water requirements of the baby birds.

The term “larva” or “larvae” as used herein preferably means the active immature form of an edible insect which can be consumed and digested by birds or reptiles. A preferred edible insect larva for birds, particularly for baby birds, more particularly for newly hatched birds, yet more particularly for newly hatched chicks, is a lesser meal worm larva.

The term “grain” as used herein preferably means any cultivated cereal that is conventionally fed to mature or immature birds or reptiles such as corn, rice, wheat and/or soybean as described in CN 104489391 A of 8 Apr. 2015. In this regard, birds or reptiles, particularly birds, more particularly baby birds, still more particularly newly hatched birds, yet more particularly newly hatched chicks, can be fed, in accordance with this invention, with one or more grains in a specially prepared and formulated mixture, such as a conventional corn- wheat- soybean-based starter mixture.

The term “deep eutectic solvent” or “DES” as used herein preferably means a mixture of water and two or more metabolites which DES can be safely consumed by a bird or reptile undergoing incubation and which has a much lower vapour pressure than water and a much lower melting point than any of its components. The metabolites of a DES can generally be any plant or animal (e.g., mammal, fish, reptile, bird or insect) metabolites, i.e., compounds naturally occurring in a plant or animal cell, but can also be synthetic metabolites, provided they can be safely consumed. For certain applications, preferred metabolites of a DES will be those found naturally in a bird or reptile that is to consume the DES. Generally preferred metabolites include sugars (particularly sucrose, D-glucose, D-galactose, D-mannose, D-fructose, D-xylose, D-trehalose, raffinose and maltose), sugar alcohols (particularly glycerol, adonitol, xylitol, ribitol, 1,2-propanediol, inosiltol, meso-erythritol and D-sorbitol), amino acids (particularly betaine, betanine, proline, arginine, asparagine, betalaine, lysine, threonine, putrescine, cadaverine, glucosamine, glutamine, and alanine), organic acids (particularly lactic acid, malic acid, citric acid, malonic acid, maleic acid, aconitic acid, L-tartaric acid, succinic acid, neuraminic acid, sialic acid, fumaric acid, aspartic acid, glutamic acid [preferably in salt form] and phytic acid [preferably in salt form]) and choline derivatives (particularly choline chloride, acetylcholine, choline citrate and choline bitartrate).

The term “bird” as used herein preferably means males or females of any avian species but is primarily intended to encompass poultry which are commercially raised for eggs or meat. Accordingly, the term “bird” is particularly intended to encompass chickens, turkeys, ducks, geese, quails, doves, ostriches, emus, guinea fowl and pheasants.

The term “birds or reptiles” as used herein preferably means baby birds or baby reptiles, more preferably baby birds, still more preferably chicks, ducklings, baby geese or baby turkeys, yet more preferably chicks. The term “baby birds or baby reptiles” as used herein preferably means birds or reptiles which have hatched less than one month previously, more preferably less than fifteen days previously.

The term “newly hatched birds or newly hatched reptiles” as used herein preferably means baby birds or baby reptiles which have hatched less than 1 day previously, still more preferably have just hatched or are about to hatch.

The term “incubation” herein preferably means the process by which oviparian animals, such as birds hatch their eggs, and to the development of the embryo within the egg after leaving the adults' tract.

The term “incubation period” herein preferably means the uninterrupted time during which a particular egg is subjected to conditions simulating brooding until hatching, i.e. emergence of the hatchlings, including any handling or transfers from e.g. an incubator to a hatchery.

In the method of this invention, food and preferably also water are fed to: i) newly hatched birds or newly hatched reptiles, preferably newly hatched birds, more preferably newly hatched chicks, ducklings, baby geese or baby turkeys, still more preferably newly hatched chicks, undergoing incubation; and/or ii) birds or reptiles, preferably baby birds or reptiles, more preferably baby birds, still more preferably chicks, ducklings, baby geese or baby turkeys, yet more preferably chicks, undergoing transport after their incubation, preferably soon or immediately after their incubation. The method involves feeding the birds or reptiles, edible insects and/or edible parts of insects during their incubation and/or transport. Preferably, whole edible insects, more preferably whole edible insects that are alive, still more preferably whole live larvae of edible insects are provided to the birds or reptiles. Also preferably, newly hatched birds or reptiles, undergoing incubation, are fed with the edible insects and/or edible insect parts less than 1 day after, still more preferably shortly before or as soon as possible after, the birds or reptiles hatch. Also preferably, birds or reptiles, undergoing transport after incubation, are fed the edible insects and/or edible insect parts shortly before or as soon as possible after transport begins of the birds or reptiles. It is believed that the edible insects and/or edible insect parts, especially whole edible insects, particularly whole edible insects that are alive, more particularly their larvae, can provide much of the food and preferably also water requirements of: newly hatched birds or reptiles for the first few days after their hatching; and birds or reptiles during a few days of their transport after incubation. It is also believed that the edible insects make it possible to reduce the use of antimicrobials, in particular antibacterial food additives and medications, due to the presence of components such as chitin and lauric acid in the insects.

Also, live insects are able to maintain their water and nutrient level under the incubation conditions, which involve a multitude of eggs in an incubator under incubation conditions. The latter involve the use of a climate chamber during the incubation, and directly after hatching.

The provision of the food and water source according to the invention is particularly relevant for those chicks that hatch first, and are maintained for a period of up to three days under the incubation conditions, while the other eggs hatch as well. The incubation method comprises a) controlling the temperature and humidity in an incubator chamber, b) operating a ventilation means to generate an air flow through the incubator chamber, and c) supplying the newly hatched chicks with a source of food and water, comprising live insects, inside, or preferably outside the hatch tray, but accessible to the chicks.

Birds and reptiles when newly hatched and undergoing incubation and birds and reptiles being transported after incubation are also preferably fed:
an additional source of water, preferably a source of water that does not dry out under prolonged heating conditions, more preferably an exogenous deep eutectic solvent that comprises water and two or more, primary metabolites, preferably selected from sugars, sugar alcohols, amino acids, organic acids and choline derivatives; in this regard, when birds or retiles are fed edible insects and/or edible insect parts, preferably whole edible insects, more preferably whole edible insects that are alive, still more preferably whole live edible insect larvae—which to a large extent are made up of water, the additional source of water need not be provided; or
an additional source of edible food, preferably derived from one or more grains, more preferably derived from corn, rice, wheat and/or soybean, still more preferably a pre-starter mixture of grains for newly hatched birds; or
both the additional source of water and the additional source of edible food; in this regard, both the additional source of water and the additional source of edible food can be separate in different containers or separate in one container or combined as a mixture in one container.

In the composition of this invention, food and preferably also water are provided for: i) newly hatched birds or newly hatched reptiles undergoing incubation; and/or ii) birds or reptiles, preferably baby birds or baby reptiles, when transporting them after their incubation, preferably soon or immediately after their incubation. The composition comprises edible insects and/or edible insect parts, preferably whole edible insects, more preferably whole edible insects that are alive, still more preferably whole live edible insect larvae. Preferably, the composition also comprises:
an additional source of water, preferably a source of water that does not dry out under prolonged heating conditions, more preferably an exogenous deep eutectic solvent that comprises water and two or more, primary metabolites, preferably selected from sugars, sugar alcohols, amino acids, organic acids and choline derivatives; in this regard, when birds or retiles are fed edible insects and/or edible insect parts, preferably whole edible insects, more preferably whole edible insects that are alive, still more preferably whole live edible insect larvae—which to a large extent are made up of water, the additional source of water need not be provided; or
an additional source of edible food, preferably derived from one or more grains, more preferably derived from corn, rice, wheat and/or soybean, still more preferably a pre-starter mixture of grains for newly hatched birds; or
both the additional source of water and the additional source of edible food. In this regard, both the additional source of water and the additional source of edible food can be separate in different containers or separate in one container or combined as a mixture in one container.
   This composition containing the edible insects and/or edible insect parts should, of course, be formulated in accordance with the dietary requirements of the birds or reptiles, taking into account the nutritional and water content of the edible insects and/or edible insect parts.

This composition is particularly useful in carrying out the above described feeding method of this invention.

In the method of this invention for incubating newly hatched birds or newly hatched reptiles and/or for transporting birds or reptiles, preferably baby birds or baby reptiles, after their incubation, preferably immediately or soon after their incubation, the birds or reptiles are fed the above-described composition of food and preferably also water when incubating and/or when transporting.

In the method of this invention for strengthening newly hatched birds or newly hatched reptiles when incubating them and/or for strengthening birds or reptiles, preferably baby birds or baby reptiles, when transporting them after their incubation, preferably immediately or soon after their incubation, the birds or reptiles are fed the above-described composition of food and preferably also water when incubating and/or when transporting.

Also in accordance with this invention, eggs of birds or reptiles preferably birds, more preferably chicks, ducklings, baby geese or baby turkeys, still more preferably chicks may be placed in stacked egg trays in a setter for incubation during their first 18 days after being laid. The eggs may then be transferred into stacked hatcher baskets to a hatcher for the last three days of their incubation. The settler and hatcher can each have a multi-level incubation shelf system that can hold a multitude of stacked egg trays or hatcher baskets, each of which holds a multitude of eggs. The settler and hatcher each typically provide the eggs with controlled air flow and temperature for incubation, advantageously in climate controlled chambers. During incubation, eggs are kept in the hatcher baskets until the birds or reptiles hatch (after about 18-21 days for chicks). After hatching, the newly hatched birds or reptiles can be transported by truck in conventional stacked transport baskets to a poultry house. The truck can have a multi-level shelf system that can hold a multitude of stacked transport baskets, each of which holds a multitude of newly hatched birds or reptiles. Throughout the incubation and subsequent transport of the birds or reptiles, they preferably remain in their hatcher and transport baskets and have access to food and water there in accordance with this invention. In this regard, conventional feed trays or feed troughs are preferably provided in each basket, containing the composition of this invention which comprises edible insects and/or edible insect parts, preferably whole live edible insect larvae. The composition can also comprise:
an additional source of water, preferably an exogenous deep eutectic solvent that comprises water and two or more, primary metabolites: or
an additional source of edible food, preferably a pre-starter mixture of grains for newly hatched birds; or
both the additional source of water and the additional source of edible food.

The following, non-limiting examples illustrate the invention.

### EXAMPLE 1

Several hatch trays comprising 20 chicken eggs (Gallus gallus domesticus) each at day 18 after laying and a food container having smooth sides that did not allow the feed insects to escape were subjected to standard incubation conditions.

Feed was supplied in the form of conventional dry chicken feed, conventional early chick feed, a combination of a deep eutectic feed source with dead lesser meal worms, with a combination of a deep eutectic feed source and live lesser meal worms , and with live lesser meal worms.

The behaviour of the chicks during and after hatching was followed by filming, and the uptake was evaluated after the chicks had hatched (after day 20).

It was found that the live insect feeds appeared to have caused the greatest picking behaviour in the newly hatched chicks. While chicks appeared to have eaten all feeds offered, the largest take up and the highest water take up was with the combination of a deep eutectic feed source with live lesser meal worms, and live lesser meal worms.

### EXAMPLE 2

5 newly hatched chicks were offered live lesser meal worms, which incited frantic picking behaviour. After one hour, all stomachs and maws were entirely filled with the lesser meal worms. This was clearly more consumption than with dry chicken feed.

Based on these results, it appears that feed containing edible insects, in particular live insects, raises the interest of newly hatched birds, more specifically chicks, to take up the feed immediately after hatching and during incubation. Also, the water content of the feed containing insects is notably higher than with conventional feed, providing the chicks with much needed water to withstand prolonged exposure under the incubation conditions.

1. A method for providing food and preferably also water for consumption and digestion by newly hatched birds or newly hatched reptiles undergoing incubation; and/or birds and reptiles, preferably baby birds and baby reptiles, being transported after incubation, preferably immediately or soon after incubation, comprising the step of:
providing, to the birds or reptiles, edible insects or their parts or both in feed troughs during the incubation or transport of the birds or reptiles.

2. (canceled)

3. The method of claim 1 wherein the edible insects are whole edible insects.

4. The method of claim 3, wherein the whole edible insects are alive.

5. The method of claim 4 wherein whole live larvae of edible insects are provided.

6. The method of claim 5 wherein the live larvae are selected from lesser meal worm (Alphitobius diaperinus), the buffalo worm (Alphitobius laevigatus) and/or the meal worm beetle (Tenebrio molitor).

7. The method of claim 1 wherein the edible insects are selected from insects that are not a known vector for pathogens that could negatively affect the bird or reptile.

8. The method of claim 1 wherein if the edible insect is a known vector, the edible insect are bred to be free from harmful pathogens for the bird or reptile.

9. The method of claim 1 wherein the edible insects or their parts have an average length of from 5 to 15 mm, wherein by average length, the larger dimension is considered as length, whereas the smaller dimension is considered as width, as edible insects typically have a larger and a smaller dimension, independently from their stage.

10. The method of claim 1 wherein the newly hatched birds or newly hatched reptiles undergoing incubation are provided with the edible insects and/or their parts in the period of from just before to less than 1 day after the birds or reptiles hatch.

11. (canceled)

12. The method of claim 1 wherein the edible insects or their parts preferably have a maximum average length of from 5 mm to 20 mm.

13. The method of claim 1 wherein the birds or reptiles are also provided with:
an additional source of water, preferably a source of water that does not dry out under prolonged heating conditions, more preferably an exogenous deep eutectic solvent that comprises water and two or more, primary metabolites, preferably selected from sugars, sugar alcohols, amino acids, organic acids and choline derivatives; or
an additional source of edible food, preferably containing one or more grains, preferably derived from corn, rice, wheat and/or soybean; or
both the additional source of water and the additional source of edible food.

14. A composition for providing food and preferably also water in feed troughs for consumption and digestion by: birds or reptiles when newly hatched and undergoing incubation; and/or birds and reptiles, preferably baby birds and baby reptiles, being transported after incubation, preferably immediately or soon after incubation, the composition comprising edible insects and/or their parts.

15. The composition of claim 14 wherein the edible insects are whole edible insects, that preferably are alive, more preferably are whole live larvae of edible insects.

16. The composition of claim 14 wherein the edible insects or their parts preferably have a maximum average length of from 5 mm to 20 mm.

17. The composition of claim 14 wherein, the birds or reptiles undergoing incubation or transport are also provided with
an additional source of water, preferably a source of water that does not dry out under prolonged heating conditions, more preferably an exogenous deep eutectic solvent that comprises water and two or more, primary metabolites, preferably selected from sugars, sugar alcohols, amino acids, organic acids and choline derivatives; or
an additional source of edible food, preferably containing one or more grains, preferably derived from corn, rice, wheat and/or soybean; or
both the additional source of water and the additional source of edible food.

18. A method for incubating newly hatched birds or newly hatched reptiles and/or transporting birds or reptiles, preferably baby birds or baby reptiles, by providing the birds or reptiles with edible insects and/or their parts in feed troughs when incubating and/or when transporting the birds or reptiles.

19. A method for strengthening newly hatched birds or newly hatched reptiles when incubating them and/or strengthening birds or reptiles, advantageously baby birds or baby reptiles, when transporting them, preferably soon or immediately after their incubation, by providing the birds or reptiles with edible insects and/or their parts in feed troughs when incubating and/or transporting the birds or reptiles.

20. The method of claim 18, wherein the edible insects are whole edible insects, that preferably are alive, more preferably are whole live larvae of edible insects.

21. The method of claim 18, wherein the edible insects or their parts have a maximum average length of from 5 mm to 20 mm.

22. The method of claim 18, wherein the birds or reptiles are also fed, during incubation or transport, with:
an additional source of water, preferably a source of water that does not dry out under prolonged heating conditions, more preferably an exogenous deep eutectic solvent that comprises water and two or more, primary metabolites, preferably selected from sugars, sugar alcohols, amino acids, organic acids and choline derivatives; or
an additional source of edible food, preferably containing one or more grains, preferably derived from corn, rice, wheat and/or soybean; or
both the additional source of water and the additional source of edible food.
